(19) United States
(12) Patent Application Publication
(10) Pub. No.: US 2007/0229826 A1
(43) Pub. Date: Oct. 4, 2007

(54) RAPID MATERIAL OPTICAL DIAGNOSTICS METHOD

(75) Inventor: MATHIAS M. SCHUBERT, LINCOLN, NE (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: BOARD OF REGENTS OF UNIVERSITY OF NEBRASKA, LINCOLN, NE (US)

(21) Appl. No.: 11/693,505

(22) Filed: Mar. 29, 2007

Related U.S. Application Data
(60) Provisional application No. 60/787,568, filed on Mar. 30, 2006.

(51) Int. Cl. G01J 4/00

(52) U.S. Cl. 356/369

(57) ABSTRACT

The present invention provides a system and method for utilizing optical measurements to determine properties of a material. Ellipsometry is used to measure the polarization state of a light beam reflected from or transmitted through a material. Utilizing ellipsometry, two or more Mueller Matrix elements are determined by variation of the polarization state of the incident light. The angular-dependences of the Mueller matrix elements are plotted in a plane, and the symmetrical relationships between the various Mueller Matrix element distributions are then be determined. Upon determining symmetrical relationships, two and/or three dimensional atomic or molecular arrangements of atoms or molecules in the material are determined. Based on the two or three dimensional atomic or molecular arrangements, a material property, such as chiralty, may be determined.

### CROSS-REFERENCE TO RELATED APPLICATIONS

This application is a U.S. non-provisional patent application claiming priority under 35 U.S.C. §119(e) from Provisional U.S. Patent Application 60/787,568, filed on Mar. 30, 2006. The foregoing application is hereby incorporated by reference.

### STATEMENT REGARDING FEDERALLY SPONSORED RESEARCH OR DEVELOPMENT

Not Applicable.

### BACKGROUND OF THE INVENTION

Currently, to evaluate chiralty properties of a specimen, the specimen may be destroyed or the evaluation may extend for a longer amount of time than desired. However, analyzers of specimen, including biological samples, blood, DNA, chemical isomers, and the like, may require an efficient method and system to evaluate chiralty properties of specimen without destroying the specimen. Accordingly, a system and method that provides quick identification of materials which differ in their chiralty properties is desirable.

### BRIEF SUMMARY OF THE INVENTION

The present invention provides a system and method for utilizing optical measurements to determine properties of a material. Ellipsometry is used to measure the polarization state of a light beam reflected off or transmitted through a material. Utilizing ellipsometry, two or more Mueller Matrix elements may be determined by variation of the polarization state of the incident light. The angular-dependences of the Mueller matrix elements may be plotted in a plane. The symmetrical relationships between the various Mueller Matrix element distributions may then be determined. Upon determining symmetrical relationships, two and/or three dimensional atomic or molecular arrangements of atoms or molecules in the material may be determined. Based on the two or three dimensional atomic or molecular arrangements, a material property, such as chiralty, may be determined.

### BRIEF DESCRIPTION OF THE DRAWINGS

FIG. 1 illustrates one embodiment of a rapid material optical diagnostics system of the present invention;

FIG. 2 schematically depicts one embodiment of an exemplary ellipsometer component;

FIG. 3 illustrates a Mueller Matrix formalism;

FIG. 4 illustrates a Jones Matrix formalism;

FIG. 5 illustrates a graph representing the angular-dependence of the Mueller matrix elements in a plane;

FIG. 6 illustrates a symmetrical relationship between the various Mueller Matrix element distributions of chevron;

FIG. 7 illustrates a symmetrical relationship between the various Mueller Matrix element distributions of chevron material at wavelength of 1550 nanometers;

FIG. 8 illustrates a non-symmetrical relationship between the various Mueller Matrix element distributions for 3-fold screw material;

FIG. 9 illustrates a non-symmetrical relationships between the various Mueller Matrix element distributions of chevron material at wavelength of 1550 nanometers; and

FIG. 10 illustrates a flow diagram providing an exemplary method for determining one or more properties of solids.

### DETAILED DESCRIPTION OF THE INVENTION

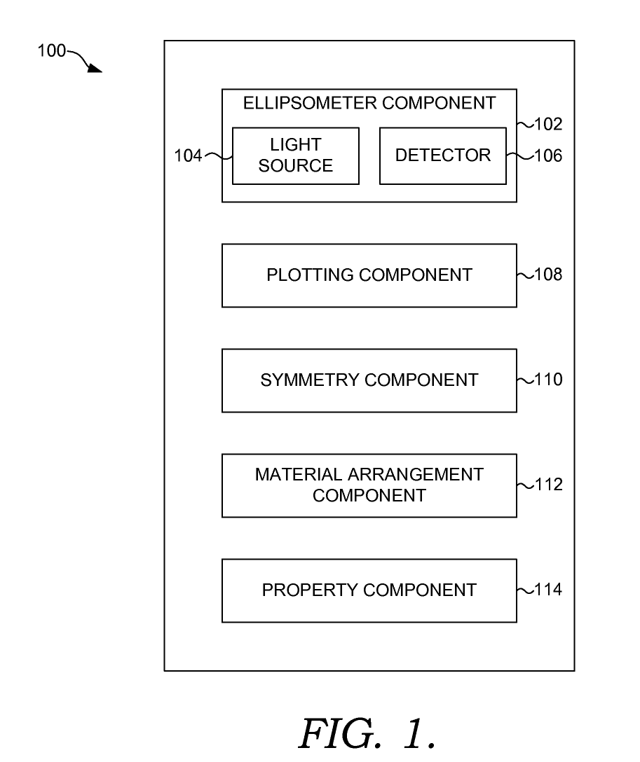

Turning now to the drawings, FIG. 1 illustrates one embodiment of a rapid material optical diagnostics system 100 of the present invention. The system 100 utilizes ellipsometry, the Mueller Matrix descriptor, and a visual or computer-aided technique to determine properties of solids from optical measurements. The system 100 comprises an ellipsometer component 102, a plotting component 108, a symmetry component 110, a material arrangement component 112, and a property component 114. It will be understood by those of ordinary skill in the art that the components illustrated in FIG. 1 are exemplary in nature and in number and should not be construed as limiting. Any number of components may be employed to achieve the desired functionality within the scope of embodiments hereof.

The ellipsometer component 102 measures the polarization state of a light beam reflected off or transmitted through a material. The ellipsometer component 102 may comprise a light source 104 and a detector 106. The light source 104 may have a known polarization state. The light source 104 may be directed at a non-normal angle of incidence to a material of interest. Detector 106 may capture the polarization state of the reflected light. Alternatively, detector 106 may capture the polarization state of the transmitted light. In one embodiment, detector 106 may capture the polarization state of the reflected light, the polarization state, or a combination thereof.

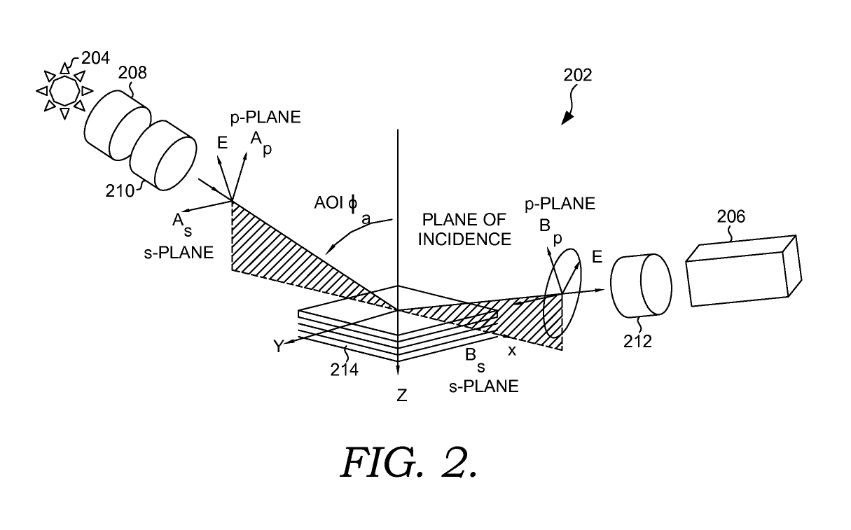

FIG. 2 depicts one embodiment of an exemplary ellipsometer component. The ellipsometer component 202 comprises a light source 204, a detector 206, a polarizer 208, a compensator 210, and an analyzer 212. The light source 204 may be directed at a non-normal angle of incidence to a material of interest 214. The polarizer 208 may convert an unpolarized or mixed-polarization beam of electromagnetic waves, e.g., light, into a beam with a single polarization state. In one embodiment, polarizer 208 may linearly polarize light source 204.

The compensator 210 may alter the polarization state of a light wave traveling through the optical device. Compensator 210 may comprise a retarder or a wave plate. In one embodiment, compensator 210 may be a wave plate comprising a birefringement crystal with a specific thickness. In such a case, the wave plate may be a quarter wave plate, a half wave plate, or other similar wave plate. A quarter wave plate may create a quarter wavelength phase shift and may change linearly polarized light to circular or may change circular polarized light to linear. A half wave plate may change one polarization by one-half a wavelength and may rotate the polarization direction of linear polarized light. In some embodiments, ellipsometer component 202 may include a phased-modulator in the incident light beam path rather than a compensator 210. In some embodiments, ellipsometer component 202 may also include a compensator that alters the polarization state of a light wave after the radiation is reflected from or transmitted through the material of interest 214.

Upon the reflection from or transmission of the light through the material of interest 214, ellipsometer component 202 may include an analyzer 212. In one embodiment, analyzer 212 may comprise a polarizer. The detector 206 receives the electromagnetic radiation reflected from or transmitted through the material of interest 214. In one embodiment, detector 206 may capture the polarization state of the reflected light. Alternatively, detector 206 may capture the polarization state of the transmitted light.

Referring again to FIG. 1, in one embodiment ellipsometer component 102 may be a spectroscopic ellipsometer. U.S. Pat. No. 5,373,359 discloses a spectroscopic ellipsometer comprising a light source, a polarization-state generator, sample and analyzer, a detection system, and a control system. According to U.S. Pat. No. 5,373,359, the light source transmits white light to the polarization-state generator, sample and analyzer. The polarization-state generator, sample and analyzer sets a polarization state of the light transmitted to the sample. The polarization-state generator, sample and analyzer may comprise a collimator, a polarization-state generator, a sample, and an analyzer. The detection system may include a diffraction grating, a photodiode detector array, and a sensor, and the detection system detects the light and thereafter provides an electrical signal that indicates the polarization change due to light reflection.

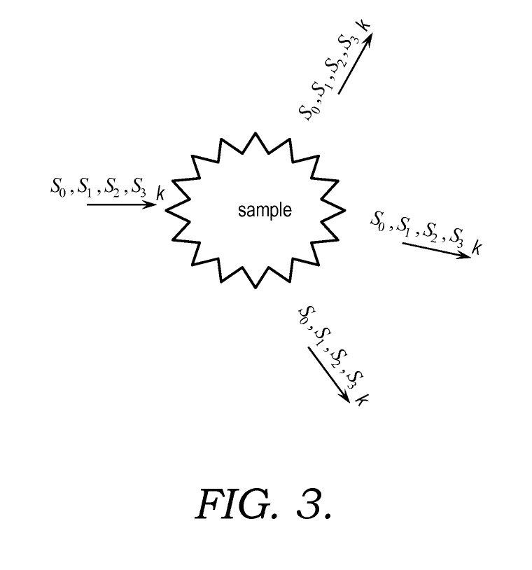

Utilizing ellipsometer component 102, two or more Mueller Matrix elements may be determined by variation of the polarization state of the incident light. The Mueller Matrix may uniquely define the optical interaction of any specific sample with any specific state of polarization and may include 16 elements. Accordingly, in one embodiment, ellipsometer component 102 may determine 16 Mueller Matrix elements by variation of the polarization state of the incident light. With reference to FIG. 3, the Mueller Matrix connects incident and emergent real-valued Stokes vector components:

$${S}_{0} = {I}_{p} + {I}_{s}$$

$${S}_{1} = {I}_{p} - {I}_{s}$$

$${S}_{2} = {I}_{45} - {I}_{- 45}$$

$${S}_{3} = {I}_{σ +} - {{I}_{σ -} \\ [ \begin{matrix}{S}_{0} \\ {S}_{1} \\ {S}_{2} \\ {S}_{3}\end{matrix} ]}_{output} = {{M}_{11} ( \begin{matrix}1 & {M}_{12} & {M}_{13} & {M}_{14} \\ {M}_{21} & {M}_{22} & {M}_{23} & {M}_{24} \\ {M}_{31} & {M}_{32} & {M}_{33} & {M}_{34} \\ {M}_{41} & {M}_{42} & {M}_{43} & {M}_{44}\end{matrix} ) [ \begin{matrix}{S}_{0} \\ {S}_{1} \\ {S}_{2} \\ {S}_{3}\end{matrix} ]}_{input}$$

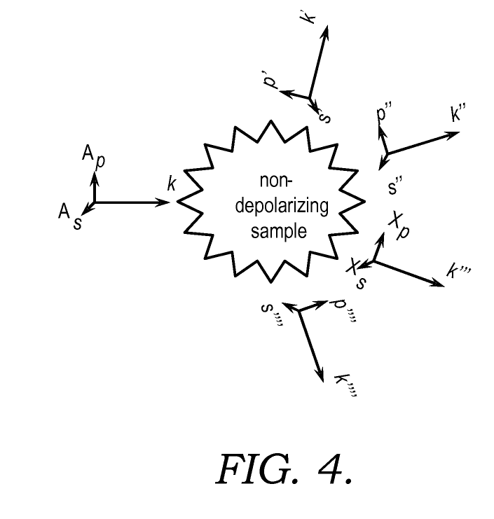

Alternatively, the Jones Matrix formalism may be used to describe how an electromagnetic wave interacts with a sample. With reference to FIG. 4, the Jones Matrix connects incident and emergent complex-valued field amplitudes:

$$( \begin{matrix}{X}_{p} \\ {X}_{s}\end{matrix} ) = [ \begin{matrix}{j}_{pp} & {j}_{sp} \\ {j}_{ps} & {j}_{ss}\end{matrix} ] ( \begin{matrix}{A}_{p} \\ {A}_{s}\end{matrix} )$$

Generalized Jones ellipsometry includes the following parameters:

$${J}_{pp} ≡ \frac{{j}_{pp}}{{j}_{ss}} = tan {Ψ}_{pp} exp {iΔ}_{pp}$$

$${J}_{ps} ≡ \frac{{j}_{ps}}{{j}_{pp}} = tan {Ψ}_{ps} exp {iΔ}_{ps}$$

$${J}_{sp} ≡ \frac{{j}_{sp}}{{j}_{ss}} = tan {Ψ}_{sp} exp {iΔ}_{sp}$$

With reference to FIG. 1, ellipsometer component 102 may further be used over a range of combinations of the angle of incidence and the azimuthal angle of the in-plane sample relative to the incident light beam. One skilled in the art will recognize that any number of combinations of the angle of incidence and the azimuthal angle of the in-plane sample relative to the incident light beam may be utilized.

In one embodiment of the present invention, ellipsometer component 102 may further comprise a computer system to perform one or more aspects of the invention, e.g., store data or perform calculations for particular aspects. The computer system may operate automatically or upon receiving user input to execute or save. In embodiments where the computer system operates automatically, the computer system may store data or perform calculations continuously or at predetermined instances.

The memory for storing data may represent the random access memory (RAM) devices comprising the main storage of the respective computer, as well as any supplemental levels of memory, e.g., cache memories, non-volatile or backup memories (e.g., programmable or flash memories), read-only memories, etc. In addition, each memory may be considered to include memory storage physically located elsewhere in a respective computer, e.g., any cache memory, or any storage capacity used as a virtual memory such as in a mass storage device.

The processor may represent one or more processors, e.g., microprocessors. The processor operates under the control of an operating system, and executes or otherwise relies upon various computer software applications, components, programs, objects, modules, data structures, etc. In an embodiment where a computer system is utilized to perform one or more aspects of the invention, the polarization state of the reflected or transmitted light, variations of the polarization state of the incident light, Mueller Matrix elements, or a combination thereof may be determined and/or stored.

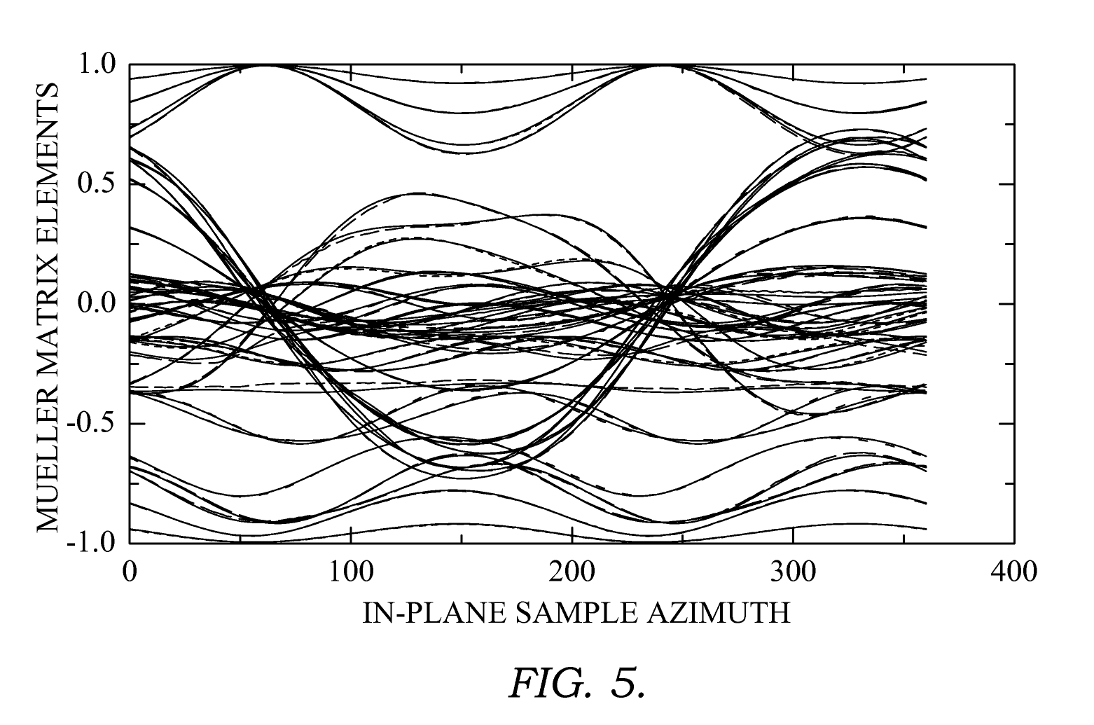

With continued reference to FIG. 1, the plotting component 108 is configured to plot the angular-dependence of the Mueller Matrix elements in a plane. FIG. 5 illustrates a graph representing the angular-dependence of the Mueller matrix elements in a plane. In particular, FIG. 5 illustrates a measurement and best-match model analysis of chevron sculptured thin film Mᵢⱼ versus sample azimuth theta and AIO based on Mueller Matrix ellipsometry. In one embodiment, pixel-density may be used to show variations from the average element with both angle of incidence and sample in-plane azimuth. Alternatively, color may be used to show variations from the average element with both angle of incidence and sample in-plane azimuth. The plotting component may comprise a computer system to perform one or more aspects of the plotting component 108.

The symmetry component 110 may be configured to determine the symmetrical relationships between the various Mueller Matrix element distributions. In addition, symmetry component 110 may be configured to determine the position within the Mueller Matrix descriptor system that is given within an appropriate coordinate system such as the p- and s-polarizations. The p- and s-polarizations are defined with respect to the vibration directions of the incident electric field vector elements. The s component oscillates perpendicular to the plane of incidence and parallel to the sample surface. The p component oscillates parallel to the plane of incidence. In one embodiment, the symmetry component may utilize a visual computer-aided technique. In an alternative embodiment, the symmetry component may utilize a pattern-recognition technique.

Based on the symmetrical relationship between the various Mueller Matrix element distributions, the material arrangement component 112 may determine the two and/or three dimensional atomic or molecular arrangements of atoms or molecules in the material. In one embodiment, a computer system may perform one or more aspects of the material arrangement component, e.g., determine the two and/or three dimensional atomic or molecular arrangements of atoms or molecules in the material and/or store data.

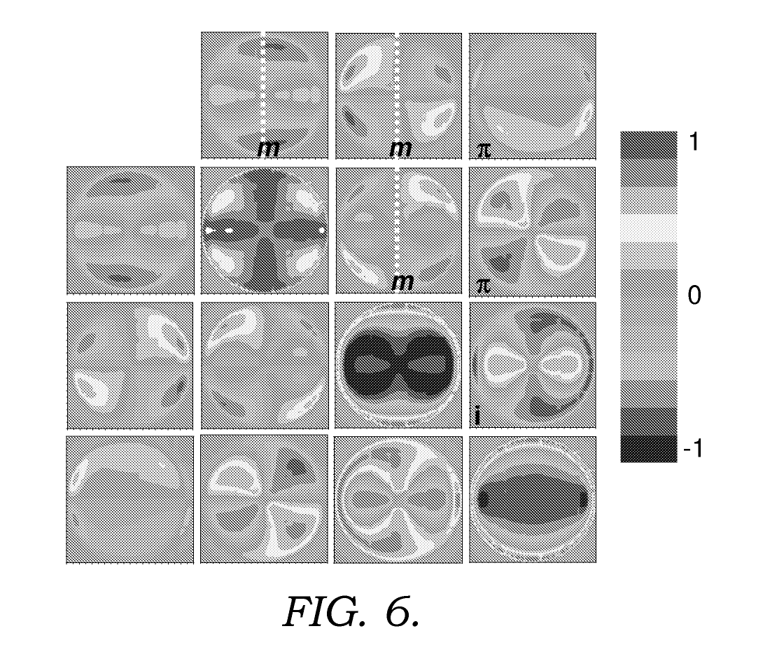

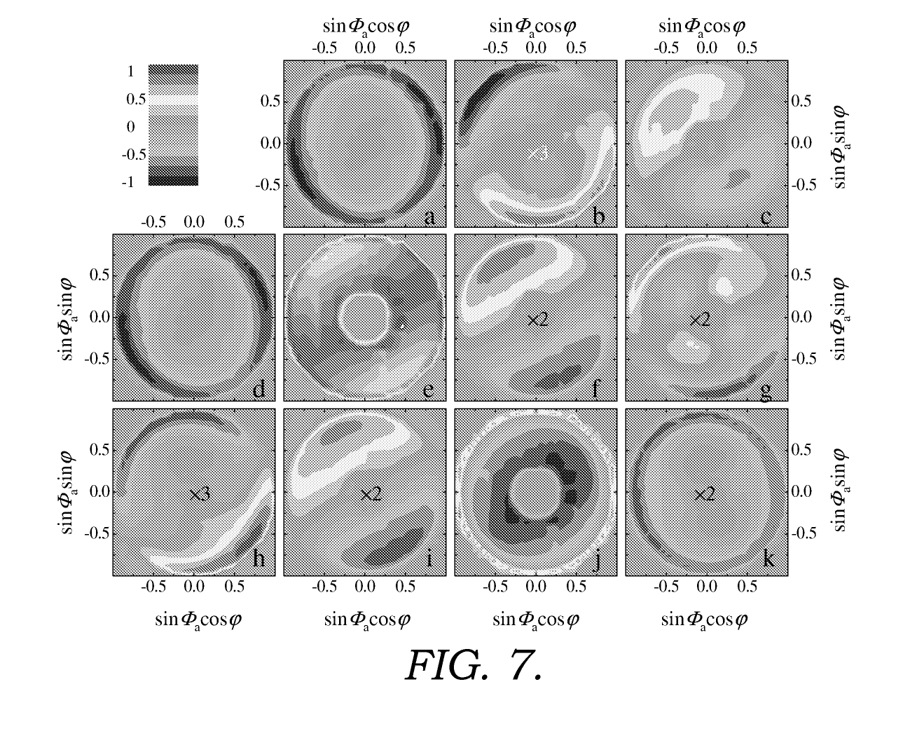

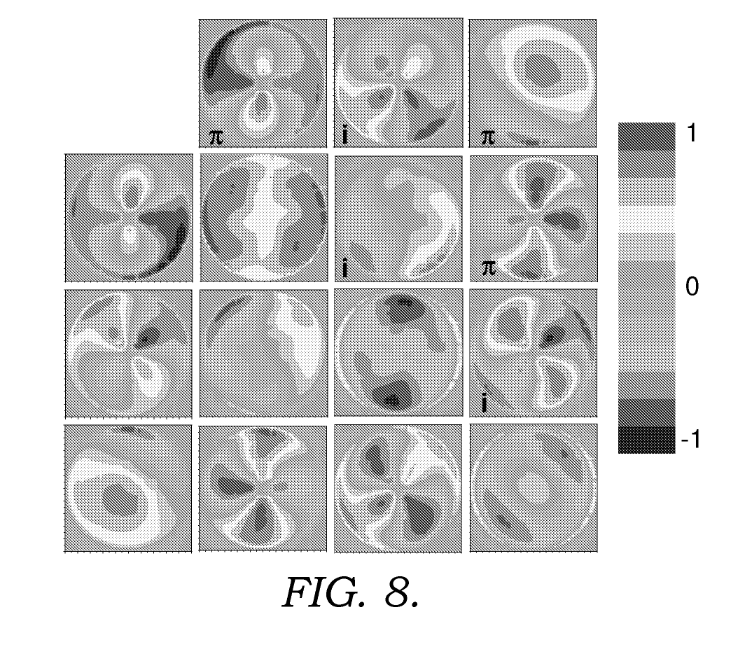

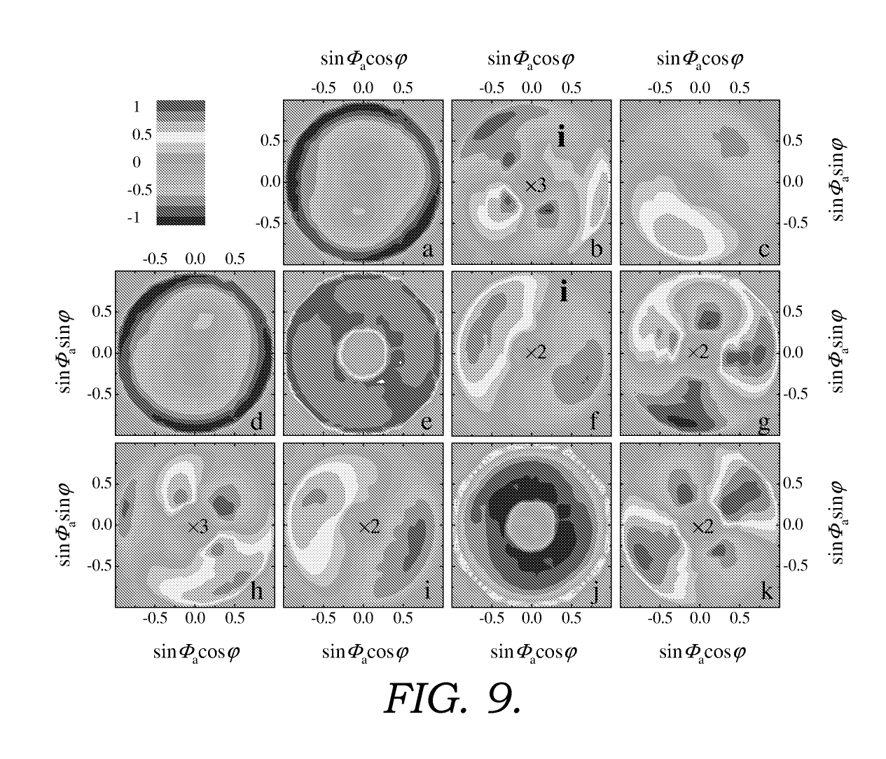

The two and/or three dimensional atomic or molecular arrangement of atoms or molecules may be utilized by the property component 114 to determine one or more properties of the material. In one embodiment, property component 114 may determine the chiralty of the material. In particular, the symmetry operation that transforms Mueller Matrix element distributions between opposite off-diagonal Matrix positions identifies the chiral or non-chiral atomic or molecular arrangement. An arrangement is chiral where the distribution is not superimposable on its mirror image. By contrast, an arrangement is non-chiral where the distribution is superimposable on its mirror image. FIGS. 6 and 7 illustrate examples where the distribution comprises a mirror plane and, accordingly, the arrangement is non-chiral. In particular, FIG. 6 illustrates a Mueller Matrix ellipsometry simulation of chevron sculptured thin film, and FIG. 7 illustrates a Mueller Matrix ellipsometry measurement of chevron sculptured thin film at a wavelength 1550 nanometers. FIGS. 8 and 9 illustrate examples where the distribution does not comprise a mirror plane and, accordingly, the arrangement is chiral. In particular, FIG. 8 illustrates a Mueller Matrix ellipsometry simulation of a three-fold screw sculptured thin film, and FIG. 9 illustrates a Mueller Matrix ellipsometry measurement of chevron sculptured thin film at wavelength of 1550 nanometers. In a chiral arrangement, inversion, rather than a mirror symmetry, may occur. In one embodiment, a computer system may perform one or more aspects of the property component, e.g., determine one or more properties of a material and/or store data.

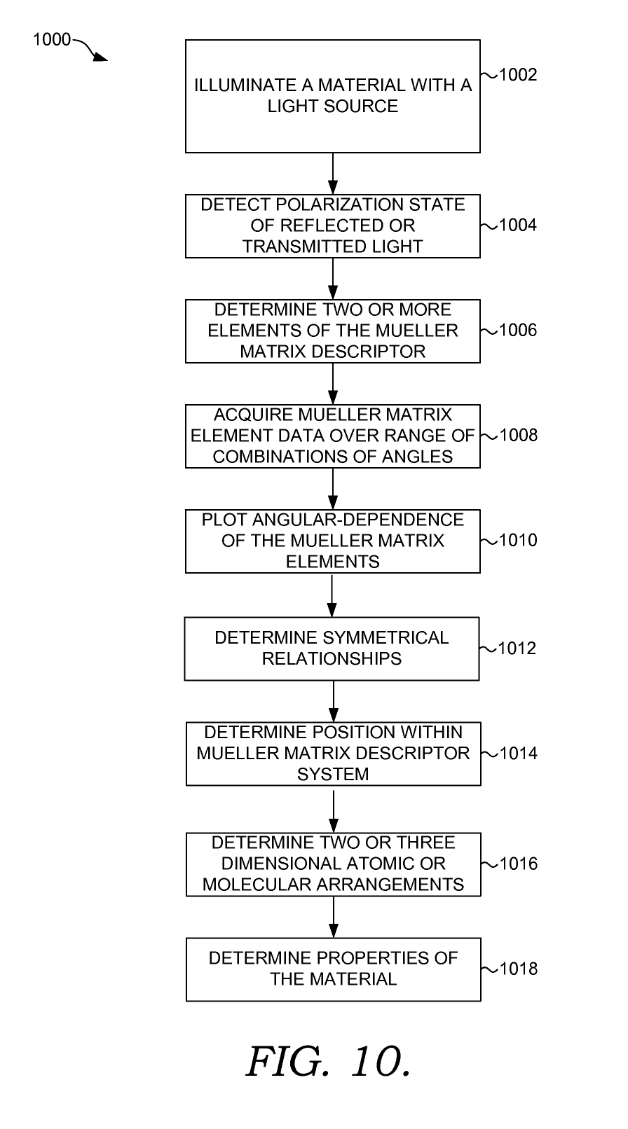

Turning now to FIG. 10, a flow diagram is provided illustrating an exemplary method 1000 for determining one or more properties of solids. As shown at block 1002, a material of interest is illuminated with a light source having a known polarization state. The light source may be directed at a non-normal angle to the material of interest. The light may be reflected off or transmitted through the material of interest. At block 1004, the polarization state of the reflected or transmitted light may be captured by a detector. By variation of the polarization state of the incident light, two or more elements of the Mueller Matrix descriptor may be determined at block 1006. The Mueller Matrix includes 16 elements that may be determined. At block 1008, Mueller Matrix element data is acquired over a range of combinations of the angle of incidence and the azimuthal angle of the in-plan sample relative to the incident light beam. The angular-dependence of the Mueller Matrix elements are plotted in a plane to show variations from the average element value with both angle of incidence and sample in-plane azimuth at block 1010. Pixel-densities or colors may be used to show variations from the average element with angle. At block 1012, the symmetrical relationships between the various Mueller Matrix element distributions are determined. The symmetrical relationships may be determined using a visual computer-aided technique or a pattern-recognition technique. At block 1014, the position within the Mueller Matrix descriptor system that is given within an appropriate coordinate system such as the p- and s-polarizations may be determined. At block 1016, symmetrical relationships are analyzed to determine the two and/or three-dimensional atomic or molecular arrangements of atoms or molecules in the material. One or more properties of a material, such as chiralty, may be determined at block 1018. Exemplary method 1000 may be repeated using a different material of interest to determine the symmetry of arrangements of atoms and molecules within the material.

The principles and modes of operation of the present invention have been described above with reference to various exemplary and preferred embodiments. As understood by those of skill in the art, the overall invention, as defined by the claims, encompasses other preferred embodiments not specifically enumerated herein.

What is claimed is:

1. A method to determine properties of solids from optical measurements, the method comprising:
illuminating a material with a light source having a known polarization state, wherein the light source is directed at a non-normal angle to the material and is received by a detector;
detecting the polarization state of the light source received by the detector such that two or more Mueller Matrix elements of the material may be determined;
acquiring data of the two or more Mueller Matrix elements based on a plurality of combinations of an angle of incidence and an azimuthal angle of the in-plan sample relative to an incident light beam;
plotting a plurality of angular-dependences of the two or more Mueller Matrix elements in a plane, wherein the plot displays variations from an average element with both an angle of incidence and a sample in-lane azimuth;
determining one or more symmetrical relationships between the two or more Mueller Matrix elements; and
analyzing the one or more symmetrical relationships to determine one or more two or three-dimensional atomic or molecular arrangements of atoms or molecules in the material.

2. The method of claim 1, wherein a visual computer-aided technique is utilized to determine the one or more symmetrical relationships between the two or more Mueller Matrix elements.

3. The method of claim 1, wherein a pattern-recognition technique is utilized to determine the one or more symmetrical relationships between the two or more Mueller Matrix elements.

4. The method of claim 1, wherein the two or more Mueller Matrix elements of the material may be determined by variation of the polarization state of the incident light.

5. The method of claim 1, wherein the light source is received by the detector after the light source is reflected from the material.

6. The method of claim 1, wherein the light source is received by the detector after the light source is transmitted through the material.

7. The method of claim 1 further comprising determining the position within the Mueller Matrix descriptor system that is given within an appropriate coordinate system.

8. The method of claim 7, wherein one or more p- and s-polarizations are determined.

9. The method of claim 1 further comprising determining one or more properties of the material.

10. The method of claim 9, wherein the one or more properties of the material includes chiralty.

11. A method to determine properties of a material, the method comprising:
acquiring data of two or more Mueller Matrix elements based on a plurality of combinations of an angle of incidence and an azimuthal angle of the in-plan sample relative to an incident light beam;
plotting a plurality of angular-dependences of the two or more Mueller Matrix elements in a plane, wherein the plot displays variations from an average element with both an angle of incidence and a sample in-lane azimuth;
determining one or more symmetrical relationships between the two or more Mueller Matrix elements; and
analyzing the one or more symmetrical relationships to determine one or more two or three-dimensional atomic or molecular arrangements of atoms or molecules in the material.

12. A system to determine one or more properties of a material, the system comprising:
an ellipsometer component configured to measure the polarization state of a light beam;
a plotting component configured to plot one or more angular-dependences of two or more Mueller Matrix elements in a plane; and
a symmetry component configured to determine one or more symmetrical relationships between the two or more Mueller Matrix elements.

13. The system of claim 12, wherein the ellipsometer component comprises a light source and a detector.

14. The system of claim 12, wherein the ellispometer component measures the polarization state of the light beam after the light beam reflects off the material.

15. The system of claim 12, wherein the ellipsometer component measures the polarization state of the light beam after the light beam transmits through the material.

16. The system of claim 12 further comprising a material arrangement component configured to determine one or more two or three dimensional atomic or molecular arrangements of atoms or molecules in the material.

17. The system of claim 16 further comprising a property component configured to determine one or more properties of the material based on the one or more two or three dimensional atomic or molecular arrangements or atoms or molecules in the material.

18. The system of claim 17, wherein one of the one or more properties is chiralty.

19. The system of claim 12, wherein the symmetry component utilizes a visual computer-aided technique.

20. The system of claim 12, wherein the symmetry component utilizes a pattern-recognition technique.
